(19) United States
(12) Patent Application Publication
(10) Pub. No.: US 2014/0275371 A1
(43) Pub. Date: Sep. 18, 2014

(54) PROCESS FOR PREPARING OLEFIN-CO TERPOLYMERS

(71) Applicant: Bayer Intellectual Property GmbH, Monheim (DE)

(72) Inventors: Thomas Ernst Müller, Aachen (DE); Christoph Gürtler, Koln (DE); Walter Leitner, Aachen (DE); Henning Vogt, Aachen (DE); Saeeda Soomro, Kassel (DE)

(73) Assignee: Bayer Intellectual Property GmbH, Monheim (DE)

(21) Appl. No.: 14/203,767

(22) Filed: Mar. 11, 2014

(30) Foreign Application Priority Data
Mar. 12, 2013 (EP) 13158815.4

(51) Int. Cl. C08G 67/02

(52) U.S. Cl. CPC C08G 67/02
USPC 524/250; 528/392; 568/862; 564/472; 524/252

(57) ABSTRACT

The present invention relates to a process for preparing olefin-CO terpolymers with the steps of:
providing a reactor;
charging the reactor with a first, gaseous olefin and with CO, such that there is a first pressure p1 in the reactor;
reacting the first olefin with CO in the presence of a catalyst in the reactor;
   wherein a second olefin is initially charged in the reactor and/or metered in during the reaction, prior to the reaction either no CO is present in the reactor or the volume ratio of first, gaseous olefin to CO is >60:40, and during the reaction the average over time of the volume ratio of gaseous olefin metered in to CO metered in is >60:40.

### FIELD OF THE INVENTION

The present invention relates to a specific process for preparing olefin-CO terpolymers in the presence of a catalyst, characterized in that at least two different olefins are used, of which at least one olefin is gaseous, and during the reaction the average over time of the volume ratio of gaseous olefin and CO is greater than 60:40.

This invention further provides olefin-CO terpolymers which are obtained by this process, and for the use thereof as polymer additives or crosslinkers, in powder coatings, as binders or, after reduction or reductive amination, as crosslinkers for polyurethanes.

### BACKGROUND OF THE INVENTION

Olefin-CO terpolymers (also referred to interchangeably in the context of the invention as “polyketones”) are usable in various ways, for example as plasticizers for PVC or as crosslinkers. In the case of the latter, the carbonyl group reacts with CH-acidic compounds in aldol reactions or with amines or hydrazine derivatives to give azomethines. CH-acidic groups adjacent to the carbonyl group can also react with other carbonyl components.

Under reductive conditions, for example through hydrogenation with hydrogen over heterogeneous metal catalysts, it is possible to obtain, from the olefin-CO terpolymers, polyalcohols which likewise find various uses, for example likewise as PVC plasticizers, or as crosslinkers for polyurethanes.

In addition, through reaction with hydroxylamine or ammonia and subsequent reduction, for example hydrogenation with hydrogen over heterogeneous metal catalysts, it is possible to obtain polyamines which can themselves serve as crosslinkers for polyurethanes.

For all applications, a low density of carbonyl groups within the polymer chain is required for various reasons. This density can be expressed by the molar CO content in the molecule. At a CO content of close to 50 mol %, a very substantially alternating olefin-CO terpolymer is present, in which the predominant proportion of CO units are separated by exactly one alkylene unit. For applications in the polyurethane sector, for example as a crosslinker after hydrogenation to give the corresponding polyalcohol or after reductive amination to give the corresponding polyamine or polyamine-polyalcohol, a number-average molecular weight≦15 000 g/mol would additionally be desirable.

Alternating olefin-CO terpolymers having a CO content of 50 mol % have been described previously in EP 0 213 671. The products described have a high melting point of 150 to 245° C. The high processing temperatures required as a result promote breakdown phenomena and/or discolouration. No statement is made as to the molecular weight.

At a high CO content, there is additionally an increased probability that aldol reactions will occur to an enhanced degree at high temperatures and/or under chemical influence, these leading to crosslinking of the polymer. Under the action of oxygen and/or UV irradiation, enhanced degradation of the polymer chains occurs in the case of olefin-CO co- or terpolymers having a high CO content. For this reason, the CO content should preferably be below 40 mol %.

Ethylene-CO copolymers having a CO content of 6 mol % to 32 mol % are described in Organometallics 2009(24), 6994. Even though FIG. 3 includes a polymer having 1 mol % of CO, this is described neither in the text nor in the supporting information. All copolymers having a CO content of ≦28 mol % have a melting point of >115° C. For an ethylene-CO copolymer having a CO content of 10 mol %, a number-average molecular weight of 4460 g/mol was measured by GPC against polystyrene standards. Since the turnover number (TON) in this example is 3270 g/mol Pd, it can be assumed that the low molecular weight results from the low TON and molecular weight control is impossible at higher conversions.

Organometallics 2005(24), 2755 describes ethylene-CO copolymers having a CO content of >35 mol %. The melting point of a copolymer with 36.8 mol % of CO is stated as 220° C. For an ethylene-CO copolymer containing 36.8 mol % of CO, after fractionation by GPC against PMMA standards, a number-average molecular weight of >300 000 g/mol was determined.

Both of the above publications describe exclusively ethylene-CO copolymers which have been obtained without incorporation of a further olefin. The melting point of these copolymers is generally above 115° C.

Chem. Commun. 2002, 964 mentions, as well as ethylene-CO copolymers having a CO content of 40 to 49 mol %, an ethylene-1-butene-CO terpolymer, the CO content and melting point of which are not discussed any further. Since this olefin-CO copolymer has been prepared with a gas mixture containing 30 bar of ethylene and 20 bar of CO, however, a CO content above 40 mol % can be assumed. All the products obtained have molecular weights of >30 000 g/mol.

EP 0 632 084 discloses incompletely alternating olefin-CO copolymers having a CO content of 20 to 47.5 mol %. As inventive examples, exclusively ethylene-CO copolymers having a CO content of ≧42.5% are cited. The copolymers obtained have a melting point of ≧210° C. No statement is made as to the molecular weight.

Olefin-CO copolymers which have been obtained by free-radical polymerization are described, for example, in U.S. Pat. No. 2,495,286, GB 1522942, US 2008/0242895 inter alia. However, the copolymers obtained, because of a higher level of branching, fundamentally differ structurally from the mainly linear olefin-CO terpolymers obtained by a catalytic route in this invention. The level of branching can be determined, for example, by NMR spectroscopy and reported as the average number of branching (i.e. at least trisubstituted) carbon atoms per 1000 carbon atoms present in the polymer. The person skilled in the art is aware that an increased level of branching leads to increased melt viscosities and hence complicates processing in the molten state. For the applications mentioned at the outset, olefin-CO copolymers having a low level of branching would therefore be desirable.

Furthermore, the use of potentially explosive free-radical initiators in free-radical polymerization processes entails increased precautionary measures, which complicate industrial application.

It is apparent from the publications cited above that there is no known catalytic process by which olefin-CO terpolymers having a CO content of ≦10 mol %, a level of branching of <60 branches per 1000 carbon atoms, a melting point of ≦115° C. and/or a number-average molecular weight of ≦15 000 g/mol can be prepared. The problem addressed by the present invention is therefore that of providing such a process.

### Embodiments of the Invention

An embodiment of the present invention is a process for preparing an olefin-CO terpolymer, comprising the steps of:
providing a reactor;
charging the reactor with a first, gaseous olefin and with CO, such that there is a first pressure p1 in the reactor;
reacting the first olefin with CO in the presence of a catalyst in the reactor;

wherein a second olefin is initially charged in the reactor and/or metered in during the reaction,

prior to the reaction either no CO is present in the reactor or the volume ratio of first, gaseous olefin to CO is >60:40 and

during the reaction the average over time of the volume ratio of gaseous olefin metered in to CO metered in is >60:40.

Another embodiment of the present invention is the process above, wherein gaseous olefin and CO are metered in at least intermittently during the reaction, with an average over time of the volume ratio of the gaseous olefin metered in to CO metered in of >60:40.

Another embodiment of the present invention is the process above, wherein the pressure in the reactor during the reaction is in the range from ≧80% of p1 to ≦120% of p1.

Another embodiment of the present invention is the process above, wherein a pressure drop which occurs during the reaction is balanced out by feeding further gaseous olefin and CO into the reactor, and wherein the average over time of the volume ratio of the further gaseous olefin fed in to the further CO fed in is >60:40.

Another embodiment of the present invention is the process above, wherein the catalyst comprises palladium.

Another embodiment of the present invention is the process above, wherein the reaction of the first olefin with CO is preceded by a homopolymerization of the first olefin or a copolymerization of a plurality of olefins in the reactor in the absence of CO.

Another embodiment of the present invention is the process above, wherein the pressure p1 is ≧20 bar to ≦300 bar.

Another embodiment of the present invention is the process above, wherein the reaction is performed at a temperature of ≧90° C. to ≦150° C.

Another embodiment of the present invention is the process above, wherein the catalyst or a mixture of the catalyst components is injected at a temperature of ≧90° C. to ≦150° C. into the reactor containing first and/or second olefin or a mixture of first and/or second olefin and CO.

Yet another embodiment of the present invention is an olefin-CO terpolymer obtained by the process above, wherein the content of CO incorporated into the terpolymer is ≦10 mol % based on all the monomers incorporated and the level of branching is <60 branches per 1000 carbon atoms incorporated within the olefin-CO terpolymer.

Another embodiment of the present invention is the olefin-CO terpolymer having a number-average molecular weight Mₙ of ≦15 000 g/mol.

Another embodiment of the present invention is the olefin-CO terpolymer having a melting point of ≦115° C.

Yet another embodiment of the present invention is a polyol compound obtained by reduction of the olefin-CO terpolymer.

Another embodiment of the present invention is a polyamine and/or polyamine-polyalcohol compound obtained by reductively aminating the olefin-CO terpolymer.

Yet another embodiment of the present invention is a method for the preparation of a polyurethane and/or polyurea polymer comprising utilizing the olefin-CO terpolymer as a polymer additive.

Yet another embodiment of the present invention is a method for the preparation of a polyurethane and/or polyurea polymer comprising utilizing the polyol compound as a polymer additive.

Yet another embodiment of the present invention is a method for the preparation of a polyurethane and/or polyurea polymer comprising utilizing the polyamine and/or the polyamine-polyalcohol compound as a polymer additive.

### DETAILED DESCRIPTION OF THE INVENTION

This problem is solved in accordance with the invention by a process for preparing olefin-CO terpolymers, comprising the steps of:
providing a reactor;
charging the reactor with a first, gaseous olefin and with CO, such that there is a first pressure p1 in the reactor;
reacting the first olefin with CO in the presence of a catalyst in the reactor;

wherein a second olefin is initially charged in the reactor and/or metered in during the reaction, prior to the reaction either no CO is present in the reactor or the volume ratio of gaseous olefin to CO is >60:40, and during the reaction the average over time of the volume ratio of gaseous olefin metered in to CO metered in is >60:40.

Compared to ethylene-CO copolymers which have been prepared under comparable conditions and have a similar CO content, the inventive olefin-CO terpolymers have lower melting points, lower melt viscosities and a lower number-average molecular weight.

Compared to olefin-CO terpolymers which have been obtained by free-radical polymerization processes, the inventive olefin-CO terpolymers obtained by a catalytic process have a lower level of branching.

Under the reaction conditions used in the process according to the invention, the volume ratio of gaseous olefin:CO can be equated to the partial pressure ratio of gaseous olefin:CO. Therefore, the partial pressure ratio can also be considered analogously instead of the volume ratio. The average over time of the volume ratio of gaseous olefin to CO during the reaction is preferably >60:40, more preferably ≧80:20 and ≦99.9:0.1 and especially preferably ≧90:10 and ≦99:1.

Olefin-CO terpolymers in the context of the invention refer to polymers which originate from the terpolymerization of at least two olefins, of which at least one olefin is a gaseous olefin, with carbon monoxide (CO) by the process according to the invention. The first olefin and the second olefin polymerize with one another, with additional incorporation of carbon monoxide into the polymer chain in the form of a carbonyl group.

The polymer chains of the inventive olefin-CO terpolymers contain at least one —CO—(C₂H₄₋ₙRₙ)ₓ—CO— fragment where x≧2, n≧1 and n≦4, and R, depending on the olefin used or the olefin mixture used, denotes hydrogen or a linear or branched, saturated or mono- or polyunsaturated C1- to C18-alkyl, -cycloalkyl, -aryl, -alkylaryl or -aralkyl radical which may additionally contain one or more heteroatoms, especially oxygen, nitrogen, sulphur, phosphorus and/or silicon, and different R may differ within one C₂H₄₋ₙRₙ unit and between different C₂H₄₋ₙRₙ units and/or different R within one C₂H₄₋ₙRₙ unit are joined to one another such that they form bi-, tri- or polycyclic systems. As well as the CO—(C₂H₄₋ₙRₙ)ₓ—CO fragments, the polymer chain may contain CO—(C₂H₄₋ₙRₙ)₁—CO fragments where n and R correspond to the above definitions. Different CO—(C₂H₄₋ₙRₙ)ₓ—CO and/or CO—(C₂H₄₋ₙRₙ)₁—CO fragments may be joined via a common CO group and hence share a CO group.

The inventive olefin-CO terpolymers contain at least two different alkenyl units C₂H₄₋ₙRₙ where n and R are each as defined above and n and/or R differ between the different alkenyl units.

As well as the branches in the polymer chain caused by the presence of the R radicals in the alkenyl units C₂H₄₋ₙRₙ, additional short-chain branches —CH(CH₃₋ₘRₘ)— or —CR(CH₃₋ₘRₘ)— may occur in the polymer chain, where m=0, 1 or 2 and R is as defined above. As end groups (EG), the inventive olefin-CO terpolymers contain, for example, carboxyl groups, formyl groups, linear or branched, saturated or mono- or polyunsaturated C1- to C20-alkyl, -cycloalkyl, -aryl, -alkylaryl or -aralkyl radicals which may additionally contain one or more heteroatoms, especially oxygen, nitrogen, sulphur and/or silicon, ester groups —OC(O)R′ or ether groups —O—R′, where R′ is a linear or branched, saturated or mono- or polyunsaturated C1- to C20-alkyl, -cycloalkyl, -aryl, -alkylaryl or -aralkyl radical which may additionally contain one or more heteroatoms, especially oxygen, nitrogen, sulphur and/or silicon, though this enumeration should not be considered to be exclusive. Examples of end groups present in the inventive olefin-CO terpolymers are especially acetate —OC(O)CH₃, methoxy —OCH₃, methyl —CH₃, ethyl —CH₂CH₃, alkyl —CH₂CH₂R or —CH(CH₃)R, ethylene —CH═CH₂, alkylene —CH═CH₂R or —CR═CH₂, 1-methylpropyl-2-ene —CH(CH₃)—CH═CH₂, 1-alkylpropyl-2-ene —CH(CH₂R)—CH═CH₂, 1-methyl-2-alkylpropyl-2-ene —CH(CH₃)—CR═CH₂, 1-methyl-3-alkylpropyl-2-ene —CH(CH₃)—CH═CHR, 1-alkyl-2-alkylpropyl-2-ene —CH(CH₂R)—CR═CH₂, 1-alkyl-3-alkylpropyl-2-ene —CH(CH₂R)—CH═CHR, where R in all cases is as defined above and may differ within one end group or in different end groups, and/or 6-alkoxy-exo-5,6-dihydrodicyclopentadienyl, 2-alkoxycyclooct-5-enyl, where the alkoxy groups are derived from a linear or branched C1- to C20-alkyl radical.

With regard to the reactor, any reaction vessel designed for the pressures and temperatures which exist during the reaction is suitable in principle. Thus, the reactors may be stirred tank reactors, autoclaves and the like; in the case of a heterogeneous catalyst, the catalyst bed may be in a fixed bed, in a trickle bed or in a fluidized bed.

“Olefin” in the context of the invention denotes olefins C₂H₄₋ₙRₙ containing at least one C═C double bond, where n≧1 and ≦4 and R is hydrogen or a linear or branched, saturated or mono- or polyunsaturated C1- to C20-alkyl, -cycloalkyl, -aryl, -alkylaryl or -aralkyl radical which may additionally contain one or more heteroatoms, especially oxygen, nitrogen, sulphur, phosphorus and/or silicon, and different R may differ within one olefin C₂H₄₋ₙRₙ and/or different R within one olefin C₂H₄₋ₙRₙ are joined to one another such that they form bi-, tri- or polycyclic systems. Examples of olefins are ethylene, propylene, 1-butene, 2-butene, isobutene, butadiene, 1-pentene, 1-hexene, 4-methyl-1-pentene, 1-heptene, 1-octene, isooctene, 1-nonene, 1-decene, styrene, 2-methylstyrene, 3-methylstyrene, 4-methylstyrene, α-methylstyrene, β-methylstyrene, 4-methoxystyrene, acrylates or methacrylates having linear or branched, saturated or mono- or polyunsaturated C1- to C20-alkyl, -cycloalkyl, -aryl, -alkylaryl or -aralkyl radicals which may additionally contain one or more heteroatoms, especially oxygen, nitrogen, sulphur, phosphorus and/or silicon, or silanes SiR¹R²R³R⁴ where R¹, R², R³, R⁴ each independently denote a linear or branched, saturated or mono- or polyunsaturated C1- to C20-alkyl, -cycloalkyl, -aryl, -alkylaryl or -aralkyl radical which may additionally contain one or more heteroatoms, especially oxygen, nitrogen, sulphur, phosphorus and/or silicon, and at least one of the R¹, R², R³ and R⁴ radicals bears a C═C double bond. Preferred olefins are ethylene, propylene, 1-butene, 1-hexene, 4-methyl-2-pentene, 1-octene, isooctene, cyclopentene, cyclopentadiene, cyclohexene, cyclooctene, cyclooctadiene, norbornene, styrene, α-methylstyrene, alkyl acrylates having linear C1- to C20-alkyl or -hydroxyalkyl radicals, trimethyl- or triethylvinylsilane and trimethyl- or triethylallylsilane. Particular preference is given to ethylene, 1-hexene, styrene, n-butyl acrylate and 4-hydroxybutyl acrylate. The term “olefin” in the context of the invention likewise relates to mixtures of two or more olefins in any composition.

“Gaseous olefin” in the context of the invention refers to olefins C₂H₄₋ₙRₙ which contain at least one C═C double bond, and which, under standard conditions (25° C., 1013 mbar), are in the gaseous or supercritical state, where n≧1 and ≦4 and R is hydrogen or a linear or branched, saturated or mono- or polyunsaturated C1- to C20-alkyl radical which may additionally contain one or more heteroatoms, especially oxygen, nitrogen, sulphur and/or phosphorus, and different R may differ within one olefin C₂H₄₋ₙRₙ. Examples of gaseous olefins are ethylene, propylene, 1-butene, 2-butene, isobutene and butadiene. The term “gaseous olefin” in the context of the invention likewise relates to mixtures of two or more gaseous olefins in any composition.

The first, gaseous olefin in the context of the invention may be any representative of the group of the gaseous olefins in the context of the invention, or mixtures of various representatives of this group in any composition.

The second olefin in the context of the invention refers to olefins in the context of the invention which are not identical to the first, gaseous olefin.

The reactor is charged, in the presence or absence of a suitable solvent, with a first, gaseous olefin or a mixture of first, gaseous olefins and CO, such that there is a first pressure p1 in the reactor, for example between 20 and 300 bar, preferably between 30 and 200 bar, more preferably between 30 and 100 bar, and, when a mixture of first, gaseous olefin and CO is used, the volume ratio between first, gaseous olefin and CO is >60:40. The presence of an additional gas, for example hydrogen or an inert gas, for example nitrogen or argon, is not ruled out, although the condition that the volume ratio between first, gaseous olefin and CO is >60:40 remains fulfilled.

The solvents used for the reaction may be aprotic solvents, for example alkanes, cycloalkanes, aromatics, for example benzene, toluene, xylenes, mesitylenes, chlorinated alkanes, for example dichloromethane, chloroform, dichloroethane, tetrachloroethane, chlorinated aromatics, for example chlorobenzene or dichlorobenzenes, open-chain or cyclic ethers, for example diethyl ether, methyl tert-butyl ether, tetrahydrofuran, 1,4-dioxane, polyethers, for example ethylene glycol dimethyl ether, diethylene glycol dimethyl ether or the higher homologues thereof, esters, for example ethyl acetate, cyclic carbonates, for example ethylene carbonate or propylene carbonate, open-chain or cyclic amides, for example N,N-dimethylformamide, N,N-dimethylacetamide, N-methylpyrrolidinone, or protic solvents such as alcohols, e.g. methanol, ethanol, isopropanol, diols, for example ethylene glycol, diethylene glycol and the higher homologues thereof, or water or mixtures of two or more of the aforementioned solvents in any desired composition. Preferred solvents are dichloromethane, methanol, tetrachloroethane, more preferably dichloromethane.

In one process variant, the second olefin can be initially charged in the reactor at the start of the reaction.

In an alternative process, the second olefin can be metered into the reactor during the reaction. The two latter process variants are not mutually exclusive. For instance, a particular proportion of the second olefin can be initially charged in the reactor prior to the reaction, and the remaining amount of second olefin can be metered in during the reaction.

The copolymerization of the olefins with CO takes place in the presence of a catalyst. The catalysts used are, for example, compounds containing at least one metal atom selected from the elements iron, cobalt, nickel, ruthenium, rhodium and/or palladium. Preferred catalysts contain nickel or palladium, particularly preferred catalysts palladium.

When a solvent is used, the concentration of the catalyst based on the metal is generally 1×10⁻⁵ to 1×10⁻¹ mmol/l, preferably 1×10⁻⁴ mmol/l to 5×10⁻² mmol/l and more preferably 5×10⁻⁴ mmol/l to 1×10⁻² mmol/l.

The catalyst or a mixture of the catalyst components, i.e. metal salt or complex and ligand, may be initially charged in the reactor either in pure form or together with a solvent and/or an olefin, or be injected into the reactor in liquid or dissolved form during the heating of the reactor to reaction temperature or on attainment of the reaction temperature. In the case of injection, the injection can be effected either in the absence or presence of solvent. Irrespective of this, the reactor at the time of injection may contain olefin or a mixture of olefin and CO, the volume ratio of gaseous olefin and CO being >60:40. However, the injection can also be effected in the absence of gaseous olefin and/or CO. The presence of a further gas, for example hydrogen, nitrogen or argon, is not ruled out in any of the process variants mentioned.

In addition to the catalyst, it is possible to use further additives which, for example, promote activation and/or stabilization of the catalyst. Possible additives are enumerated, for example, in Dalton Trans. 2008, 4537. More particularly, these include methylaluminoxane (MAO), [CPh₃][B(C₆F₅)₄] and other tetraarylborate salts, B(C₆F₅)₃ and sulphonic acids, for example 4-toluenesulphonic acid. These additives can be introduced into the reaction mixture either in a mixture with the catalyst or separately, prior to or after addition of the catalyst.

With regard to the reaction conditions, the reaction is generally initiated when the catalyst is in contact with the olefin and CO at a temperature of about ≧90° C. and ≦150° C.

The reaction temperature during the terpolymerization is generally ≧90° C. and ≦150° C. The temperature can be set by external and/or internal heating of the reactor. Preference is given to regulating the reaction temperature via the internal reactor temperature. Because of the high exothermicity of the reaction, additional protection from overheating of the reactor and of the reaction mixture by counter-cooling is advantageous. This can be effected by cooling the outer reactor wall and/or preferably by means of appropriate internals, for example a cooling coil, within the reactor. The counter-cooling is preferably integrated into the temperature control system.

The reaction time in the copolymerization can be selected freely. However, the reaction time should be longer than the period which is required for initiation of the reaction. Without being tied to a theory, initiation may be present when the reaction proceeds initially at slower reaction rates than at a later juncture. The period which is required for initiation of the reaction can be determined, for example, by monitoring the conversion of gaseous olefin and CO. If, for example, in the case of a palladium-catalysed reaction, the conversion per minute increases within 5 minutes by a factor of greater than or equal to 1.1 and, in absolute terms, is greater than 1.5 g/mmol_{Pd}·min, the initiation of the reaction can be considered to be complete. Depending on the process variant selected, the conversion can be monitored, for example, by determining the pressure drop during the reaction and/or the volumes of the gases supplied as a function of time. The maximum reaction time is limited merely by technical factors, for example reactor volume, stirrability and/or mass transfer.

The terpolymerization can be ended by cooling the reactor to a temperature below 90° C., preferably 50° C., and/or releasing the excess pressure. Additionally or alternatively, reagents which deactivate the catalyst can be added. Examples of these which can be used include hydrogen, water, ammonia, primary or secondary amines, diols or mixtures thereof, in a composition to be selected freely.

For isolation of the olefin-CO terpolymers, solvents and/or unreacted liquid olefins, if present, are removed after the excess pressure has been released. This can be effected by filtering and optionally washing the solid obtained with one of the abovementioned solvents. Alternatively or additionally, volatile components can be removed by distillation thereafter. This can be effected at temperatures between 20° C. and 90° C. (inclusive), and optionally at a reduced pressure≧1×10⁻³ mbar and <1013 mbar. Further purification steps, for example melt crystallization, precipitation or recrystallization from a solution of the copolymer in suitable solvents, optionally at elevated temperatures up to 120° C., or thin-film evaporation may follow, but are not absolutely necessary.

Further embodiments of the present invention are described hereinafter. They can be combined with one another as desired, unless the opposite is absolutely clear from the context.

In one embodiment, the reactor containing the catalyst or the catalyst components and second olefin is charged with a mixture comprising first, gaseous olefin and CO to a pressure p≦p1, the volume ratio of gaseous olefin:CO being >60:40. The reactor is subsequently heated to reaction temperature, attaining the pressure p1 in the reactor. The terpolymerization reaction commences, for example, when a temperature of about 90° C. is exceeded.

In an alternative embodiment, the above-described embodiment can also be conducted in the absence of the second olefin at the start of the reaction and the second olefin can be metered in during the heating and/or immediately after or with a time delay after the heating. In this embodiment too, it should be ensured that the ratio of gaseous olefin to CO is >60:40.

In a further embodiment, the reactor containing the catalyst or the catalyst components and second olefin is heated to reaction temperature and the reactor is charged at reaction temperature with a mixture comprising first, gaseous olefin and CO to a pressure p1, the volume ratio of gaseous olefin:CO being >60:40. In that case, the terpolymerization reaction generally commences with the charging of the reactor.

In an alternative embodiment, the above-described embodiment can also be conducted in the absence of the second olefin at the start of the reaction and the second olefin can be metered in during the heating and/or immediately after or with a time delay after the heating, or during the charging of the reactor with the mixture comprising first, gaseous olefin and CO. In this embodiment too, it should be ensured that the ratio of gaseous olefin to CO is >60:40.

In a preferred embodiment, the reactor containing a mixture of first, gaseous olefin and CO in a volume ratio of gaseous olefin:CO>60:40, and also second olefin, at a pressure p<p1 is heated to reaction temperature, attaining a pressure p′<p1 on attainment of the reaction temperature in the reactor. On attainment of the reaction temperature, the catalyst or a mixture of the catalyst components is injected, the pressure p1 being attained and the terpolymerization commencing with the injection.

In an alternative embodiment, the above-described embodiment can also be conducted in the absence of the second olefin at the start of the reaction and the second olefin can be metered in during the heating and/or immediately after or with a time delay after the heating or the injection of the catalyst or of the catalyst components. In this embodiment too, it should be ensured that the ratio of gaseous olefin to CO is >60:40.

In one embodiment of the process according to the invention, first, gaseous olefin and CO and optionally second olefin are metered into the reactor at least intermittently during the reaction, such that the average over time of the volume ratio of gaseous olefin and CO metered in is >60:40. This can be effected by continuous metered addition of the separate gaseous components, gaseous olefin and CO, in a volume flow ratio of >60:40, or of a mixture of gaseous olefin and CO in a volume ratio of >60:40. Alternatively, alternating or simultaneous pulsed metered addition of separate volumes of gaseous olefin and CO can be effected in a volume ratio averaged over time of gaseous olefin:CO of >60:40 or pulsed metered addition of a mixture of gaseous olefin and CO in a volume ratio of >60:40. Preference is given to the continuous metered addition of the separate gaseous components or of a mixture.

The metered addition is performed in such a way that the pressure in the reactor during the copolymerization is, for example, between 20 and 300 bar, preferably between 30 and 200 bar, more preferably between 30 and 100 bar.

The metering rate can be regulated manually by continuous or repeated setting of the pressure with the gases to be metered in, observing a volume ratio averaged over time of gaseous olefin:CO of >60:40. Preference is given to metered addition with the aid of mass flow regulators or Cori-Flow regulators which are connected to a digital pressure sensor and compensate differentially for the pressure drop, which occurs during the reaction, by metered addition of gaseous olefin and CO in a volume flow ratio of gaseous olefin:CO of >60:40, or of a mixture of gaseous olefin and CO in a volume ratio of gaseous olefin:CO of >60:40.

In one embodiment of the process according to the invention, the pressure in the reactor during the reaction is in the range from ≧80% of p1 to ≦120% of p1, preferably ≧90% of p1 to ≦110% of p1, more preferably ≧95% of p1 to ≦105% of p1.

In a further embodiment of the process according to the invention, the pressure drop which occurs during the reaction is balanced out by feeding further gaseous olefin and CO into the reactor, the average over time of the volume ratio of the further gaseous olefin fed in to the further CO fed in being >60:40.

In a further embodiment of the process according to the invention, the catalyst comprises palladium. In a preferred embodiment, a catalyst containing palladium and preferably an anionic bidentate ligand containing a phosphorus atom bridged to an oxygen anion over at least two and a maximum of four further atoms is used. The oxygen anion is preferably in the form of a sulphonate group. The bridge to the oxygen anion preferably contains a C═C double bond, which is more preferably part of an aromatic system. The phosphorus atom is preferably in the oxidation state of 3 and bears two further alkyl or aryl substituents as well as the bridging substituent. More preferably, the phosphorus atom bears two ortho-alkoxy-substituted aryl groups as substituents as well as the bridging substituent. Very particularly preferred ligands are phosphine-sulphonato ligands of the formula I

[chemical structure]

where

R″ is a linear or branched, saturated or mono- or polyunsaturated C1- to C20-alkyl or aryl radical which may additionally contain one or more heteroatoms, especially oxygen, nitrogen, sulphur and/or phosphorus,

and X and Y are each independently hydrogen or one or more linear or branched, saturated or mono- or polyunsaturated C1- to C20-alkyl, -aryl, -alkylaryl, -arylalkyl, -alkyloxy, -aryloxy, -alkylaryloxy or -arylalkoxy radical which may additionally contain one or more heteroatoms, especially oxygen, nitrogen, sulphur or phosphorus.

Further substituents on the aromatic ring systems, for example further linear or branched, saturated or mono- or polyunsaturated C1- to C20-alkyl, -aryl, -alkylaryl, -arylalkyl, -alkyloxy, -aryloxy, -alkylaryloxy or -arylalkoxy radicals, halogen atoms, especially chlorine or fluorine, nitro groups and/or sulpho groups, are not ruled out. In addition, the aromatic rings may independently be part of a bi-, tri-, tetracyclic or higher ring system.

In a preferred embodiment, a complex containing palladium and the ligand in a molar ratio of 1:1 is used. Preferred complex catalysts are Pd(L̂L′)(P̂O) where P̂O is a ligand of the formula I and L̂L′ is 2-alkoxycyclooct-5-enyl or 6-alkoxy-exo-5,6-dihydrodicyclopentadienyl, where the alkoxy groups are derived from linear or branched C1- to C20-alkyl radicals. More preferably, for the ligands P̂O of the formula I, R″═CH₃, X═H and Y═H or CH₃ and, for the alkoxy groups in L̂L′, methoxy and ethoxy.

In a further embodiment of the process according to the invention, the catalyst is formed in situ in the reactor from precursor compounds. In a preferred embodiment, the catalyst is generated before the reaction or in situ by mixing a metal salt or complex with the ligand in protonated or deprotonated form in a molar metal:ligand ratio of 1:0.5 to 1:5, preferably 1:0.8 to 1:2, more preferably 1:1 to 1:1.5, in a suitable solvent from the abovementioned selection. Preferred metal salts or complexes are nickel or palladium salts or complexes, for example Ni(acac)₂, Ni(cod)₂, [Ni(allyl)Cl]₂, [Ni(allyl)Br]₂, Ni(PPh₃)PhCl, Ni(dme)Br, Pd(OAc)₂, [Pd(allyl)Cl]₂, [Pd(allyl)Br]₂, PdMeCl(cod), [Pd(L̂L′)Cl]₂, more preferably Pd(OAc)₂, [Pd(L̂L′)Cl]₂ (where acac=acetylacetonate, cod=1,5-cyclooctadiene, dme=dimethoxyethane and L̂L′ is as defined above).

In a further embodiment, the reaction of the first olefin with CO is preceded by a homopolymerization of the first olefin or a copolymerization of a plurality of olefins in the absence of CO in the reactor. This embodiment offers the advantage that possible initiation periods with low reaction rate on commencement of the polymerization reaction are avoided. This leads to a higher turnover frequency (TOF), expressed in g_{product}/(mmol_{Pd}×h), compared to process variants in which the terpolymerization of olefins and CO is conducted without prior homopolymerization of the first olefin or copolymerization of a plurality of olefins in the reactor.

In one embodiment, the reactor containing the catalyst or the catalyst components and second olefin is charged with first, gaseous olefin in the absence of CO at a pressure p<p1. The reactor is subsequently heated to reaction temperature, attaining the pressure p1 in the reactor. When a temperature of about 90° C. is exceeded, the copolymerization of the first, gaseous olefin and the second olefin commences. The terpolymerization with CO is conducted by metered addition of first, gaseous olefin and CO in a volume ratio averaged over time of gaseous olefin:CO of >60:40.

The metered addition of first, gaseous olefin and CO can be effected directly after the commencement of the copolymerization of first, gaseous olefin and second olefin, or with a time delay.

In an alternative embodiment, the above-described embodiment can also be conducted in the absence of the second olefin at the start of the reaction and the second olefin can be metered in at a later juncture. This can be done, for example, during the heating and/or immediately after or with a time delay after the heating and/or in parallel to the metered addition of the mixture of first, gaseous olefin and CO. In this embodiment too, it should be ensured that the average over time of the ratio of gaseous olefin to CO is >60:40.

In a preferred embodiment, the reactor containing first, gaseous olefin and second olefin is heated to reaction temperature in the absence of CO, attaining a pressure p′<p1 in the reactor on attainment of the reaction temperature. On attainment of the reaction temperature, the catalyst or the catalyst components are injected, the pressure p1 being attained and the copolymerization of the first and second olefins commencing with the injection. The terpolymerization with CO is initiated by metered addition of first, gaseous olefin and CO in a volume ratio averaged over time of gaseous olefin:CO of >60:40. The metered addition of gaseous olefin and CO can be effected directly after the commencement of the copolymerization of the first, gaseous olefin and the second olefin, or with a time delay.

In an alternative embodiment, the above-described embodiment can also be conducted in the absence of the second olefin at the start of the reaction and the second olefin can be metered in at a later juncture. This can be done, for example, during the heating and/or immediately after or with a time delay after the heating and/or in parallel to or with a time delay after the injection of the catalyst or of the catalyst components. In this embodiment too, it should be ensured that the average over time of the ratio of gaseous olefin to CO is >60:40.

Alternatively, the catalyst or a mixture of the catalyst components can be injected into the reactor containing first, gaseous olefin and optionally second olefin with the aid of a mixture of gaseous olefin and CO in a volume ratio of gaseous olefin:CO of >60:40. Because of the negligible CO content in the reactor at the time of injection, the injection initiates homopolymerization of the first, gaseous olefin or copolymerization of the first, gaseous olefin with the second olefin, and this becomes a co- or terpolymerization on further metered addition of the mixture of gaseous olefin and CO. If a homopolymerization of the first, gaseous olefin is conducted at the start of the reaction in the absence of the second olefin, the second olefin is metered in at a later juncture. This can be done either in parallel to and/or with a time delay after the injection of the catalyst or of the catalyst components.

In a further embodiment of the process according to the invention, the pressure p1 is ≧20 bar to ≦300 bar. Preferred pressures are ≧30 to ≦200 bar, more preferably ≧30 bar ≦80 bar.

In a further embodiment of the process according to the invention, the reaction is conducted at a temperature of ≧90° C. to ≦150° C., preferably ≧95° C. and ≦130° C., more preferably ≧100° C. and ≦120° C.

In a further embodiment of the process according to the invention, the ratio of first, gaseous olefin to CO during the reaction is variable over time. In this way, it is possible to obtain gradient polymers.

In a further embodiment of the process according to the invention, the catalyst or a mixture of the catalyst components is injected at a temperature of ≧90° C. to ≦150° C. into the reactor containing first and/or second olefin or a mixture of first and/or second olefin and CO. The advantage of this embodiment is that the starting time of the polymerization reaction and the starting conditions, especially pressure and temperature, are clearly defined. This leads, more particularly, to a more homogeneous molecular weight distribution in the olefin-CO terpolymer obtained. Moreover, any possible deactivation of the catalyst during the heating operation is avoided.

The present invention further relates to an olefin-CO terpolymer obtainable by a process according to the invention, wherein the content of CO incorporated into the copolymer is ≦10 mol % based on all the monomers incorporated. The determination of the content of CO incorporated is described in detail in the experimental section below. Preferably, the content of CO incorporated into the terpolymer based on all the monomers incorporated is ≧0.1 mol % to ≦10 mol % and more preferably ≧0.5 mol % to ≦4 mol %.

The inventive olefin-CO terpolymers have a level of branching of <60, preferably <20, more preferably <17, branches per 1000 carbon atoms. The level of branching indicates the average number of branches per 1000 carbon atoms present in the polymer and can be determined, for example, by ¹³C NMR spectroscopy via the ratio of the area integrals of the signals for branching (i.e. at least trisubstituted carbon atoms) I_{C br.} to the sum total of the area integrals Iᵢ of all the signals for the carbon atoms i present in the polymer.

Since every branch introduces an additional end group into the polymer, the level of branching can likewise be determined via the average number of additional end groups, i.e. of the end groups present in branched chains in addition to the two present theoretically in a linear chain, per 1000 carbon atoms present in the polymer.

The level of branching VG is then, according to formula (II)

$$VG = 1000 \times \frac{{n}_{EG , Mol} - 2}{{n}_{C , Mol}} \qquad ( II )$$

where n_{EG, Mol} is the average number of end groups per molecule and n_{C, Mol} is the average total number of carbon atoms per molecule. This determination can be effected, for example, by means of ¹H NMR spectroscopy and is described in detail in the description of the methods.

The inventive olefin-CO terpolymers generally have a melt viscosity below 1.4 Pa·s at 120° C.

In one embodiment of this olefin-CO terpolymer, it has a number-average molecular weight Mₙ of ≦15 000 g/mol. This molecular weight can be determined by means of NMR spectroscopy or gel permeation chromatography, as explained in the experimental section. The molecular weight Mₙ is preferably ≧500 g/mol to ≦15 000 g/mol, more preferably ≧900 g/mol to ≦5000 g/mol.

In a further embodiment of this olefin-CO terpolymer, it has a melting point of ≦115° C. The melting point is preferably ≧−80° C. to ≦115° C., more preferably ≧0° C. to ≦113° C. The melting point can be determined by means of differential scanning calorimetry (DSC) at a heating rate of 10 K/min, as explained in the experimental section.

The present invention further provides a polyol compound obtainable by reducing an inventive olefin-CO terpolymer. Under reductive conditions, it is possible to obtain, from the olefin-CO terpolymers, polyalcohols which likewise find various uses, for example as plasticizers or in the preparation of polyurethane polymers or formaldehyde resins.

The reduction can be conducted, for example, by hydrogenation with hydrogen over heterogeneous or homogeneous metal catalysts. It is alternatively possible to reduce with alkali metals or hydride reagents, for example sodium borohydride, lithium aluminium hydride, borane (for example as the tetrahydrofuran or dimethyl sulphide complex), alkyl- or dialkylboranes or silanes having the structure SiH₄₋ₐRₐ where a=1, 2 or 3 and R=alkyl or aryl radical.

The hydrogenation with hydrogen can be conducted, for example, by processes which are described in J. Polymer Science (1998), 889 and Recent Research Developments in Polymer Science (1999), 355, JP 01-149828, JP 11-035676, JP 11-035677, EP 0 791 615 A1, JP 02-232228, EP 830 932 A2, EP 0 735 081 A2, JP 10-081745 and JP 09-235370.

In a preferred process, the reduction of the olefin-CO terpolymers to the corresponding polyalcohols is effected with molecular hydrogen using a heterogeneous hydrogenation catalyst. The hydrogenation is effected preferably at temperatures between 20° C. and 200° C. and at pressures between 10 bar and 100 bar. The content of heterogeneous hydrogenation catalyst may, for example, be 0.01% by weight to 100% by weight (metal content based on the polymer), preferably 0.1% by weight to 40% by weight.

Preferred catalysts contain the elements cobalt, nickel, ruthenium, rhodium and/or iridium. The catalysts can be used in the form of Raney catalysts or on suitable supports. Particular preference is given to using Raney nickel, Raney cobalt, or supported cobalt, nickel, ruthenium and rhodium catalysts. The catalysts may also be present as mixtures of the preferred elements cobalt, nickel, ruthenium, rhodium, iridium with one another, or contain ≦50% by weight, based on the metal content, of other elements, for example rhenium, palladium or platinum.

The heterogeneous hydrogenation catalyst may additionally be free of palladium and platinum, “free of” including impurities unavoidable in an industrial context.

Suitable support materials are particularly carbon and oxides, such as silicon dioxide, aluminium dioxide, mixed oxides composed of silicon dioxide and aluminium dioxide, and titanium dioxide.

The hydrogenation can be conducted in the presence or absence of solvents. Suitable solvents are particularly C₁- to C₈-alcohols and mixtures of these with one another or with other solvents such as THF or 1,4-dioxane.

In one variant, the hydrogenation is conducted at a hydrogen pressure of ≦100 bar. This should be understood to mean the hydrogen pressure which exists on commencement of the hydrogenation reaction if the reaction temperature envisaged has already been attained. For example, a hydrogen pressure of 80 bar can be set at room temperature, which rises to 100 bar after heating to a reaction temperature of approx. 200° C. This hydrogen pressure is preferably ≧40 bar to ≦100 bar. Particular preference is given to a hydrogen pressure of ≧80 bar to ≦100 bar.

In a further variant, the hydrogenation is effected in the presence of a solvent or solvent mixture comprising hydroxyl groups. The term “solvent comprising hydroxyl groups” includes water. One example of a particularly suitable solvent is 2-propanol (isopropanol). A further example is a mixture of 2-propanol with water in a volume ratio of ≧5:1 to ≦10:1. The component containing hydroxyl groups in the solvent mixture may also be provided by water alone. One example thereof is a mixture of 1,4-dioxane with water in a volume ratio of ≧5:1 to ≦10:1.

The polyalcohols obtained by reduction of an olefin-CO terpolymer prepared by the process according to the invention are of particularly good suitability as plasticizers, crosslinkers or binders for coating materials chemically crosslinked with polyisocyanates or formaldehyde resins. Therefore, the present invention further relates to the use of polyalcohols obtained by reduction of an olefin-CO terpolymer prepared by the process according to the invention for preparation of polyurethane polymers or formaldehyde resins, or as plasticizers.

The present invention likewise relates to a polyamine and/or polyamine-polyalcohol compound obtainable by reductively aminating an inventive olefin-CO terpolymer. Through reductive amination of the olefin-CO terpolymers (prepared by the process according to the invention), it is possible to prepare polyamines or polyamine-polyalcohols containing both amino and hydroxyl groups.

The polyamines or polyamine-polyalcohols obtained by reductive amination of the olefin-CO terpolymers are co-reactants of interest, for example for isocyanates or epoxides. Molecules containing more than two amine or hydroxyl groups are crosslinkers of interest, which, together with amine- or hydroxyl-reactive compounds, such as polyisocyanates or polyepoxides, can be combined to form three-dimensional networks. To control the reactivity, the primary amino groups can also be reacted with maleic esters to give aspartic esters, or with ketones or aldehydes to give ketimines or aldimines. In addition, the amine groups can be reacted with phosgene to give isocyanates. These polyisocyanates are likewise polymer units of interest.

The reductive amination can be effected by reaction of the olefin-CO terpolymers (obtained by the process according to the invention) with hydroxylamine or hydroxylamine hydrochloride to give the corresponding polyoximes and subsequent reduction of the polyoximes obtained.

For the formation of the polyoximes from the olefin-CO terpolymers (obtained by the process according to the invention), hydroxylamine is used in one- to ten-fold molar amounts based on the carbonyl groups present in the olefin-CO terpolymers obtained by the process according to the invention. Preference is given to using hydroxylamine as an aqueous solution or in substance. However, it can also be released in situ from salts of hydroxylamine, such as hydrochloride or sulphate, with bases in aqueous or alcoholic solution. The reaction of the olefin-CO terpolymers obtained by the process according to the invention with hydroxylamine can be conducted in a biphasic mixture. Preference is given to using a biphasic mixture which forms from the olefin-CO terpolymer (obtained by the process according to the invention) or a solution of the olefin-CO terpolymer (obtained by the process according to the invention) in an inert solvent such as benzene, toluene, chlorobenzene, dichlorobenzene, chloroform, dichloroethane or tetrachloroethane, and the aqueous hydroxylamine solution. In addition, it is also possible to use at least partly water-soluble solvents which are inert towards hydroxylamine, such as methanol, ethanol, isopropanol, n-propanol, n-butanol, dioxane, tetrahydrofuran (THF), N,N-dimethylformamide (DMF), N-methylpyrrolidone (NMP) or N,N-dimethylacetamide as solubilizers. The reaction is conducted at temperatures of 0 to 130° C. Subsequently, the polyoxime can be isolated by phase separation, filtration or/and distillative removal of the volatile constituents of the reaction mixture.

The polyoximes which have been prepared from the olefin-CO terpolymers (obtained by the process according to the invention) are reduced with a suitable reducing agent, preferably molecular hydrogen with use of a selective homogeneous or heterogeneous hydrogenation catalyst. The hydrogenation with hydrogen is effected at temperatures of 20 to 200° C., preferably of 80 to 180° C., more preferably of 120 to 160° C., at pressures of 10 to 200 bar, preferably 10 to 100 bar, more preferably 10 to 50 bar, in the presence of 0.1 to 20% by weight of hydrogenation catalysts, such as for example cobalt, nickel, ruthenium, rhodium, palladium, iridium, platinum. The catalysts can be used in the form of Raney catalysts or on suitable supports. Preference is given to using Raney cobalt, Raney nickel, or supported cobalt, nickel or ruthenium catalysts. Suitable support materials are particularly carbon and oxides, such as silicon dioxide, aluminium dioxide, mixed oxides composed of silicon dioxide and aluminium dioxide, and titanium oxide. Preferably, the hydrogenation is conducted in the presence of ammonia, more preferably in an equimolar amount based on oxime groups. The hydrogenation can be conducted in the presence or absence of solvents. Examples of suitable solvents are THF, dioxane, or C1-C4 alcohols. Other reducing agents are alkali metals or the hydrides, alanates or boranates thereof.

In an alternative process, the reductive amination of the olefin-CO terpolymers (obtained by the process according to the invention) can be obtained directly by the reaction thereof with ammonia and subsequent reduction, in which case the two process steps of reaction with ammonia and reduction can be performed simultaneously in a common reactor.

In one variant of the process for direct reductive amination of the olefin-CO terpolymers (obtained by the process according to the invention), the reactor is a trickle bed reactor. By means of such a reactor, it is advantageously possible to achieve a high reaction temperature and a high catalyst/substrate ratio. Preferably, the reaction mixture comprising gas phase and liquid phase is passed in cocurrent downwards through the catalyst bed. However, gas phase and liquid phase can also be passed through the catalyst bed upwards in cocurrent or in countercurrent. In an alternative variant, the flow is from below towards a moving catalyst bed. Gas phase and liquid phase can be contacted with one another upstream of the reactor or within the reactor or in the catalyst bed.

The gas phase comprises hydrogen and gaseous ammonia, and optionally inert gas and/or solvent vapours. The liquid phase consists of the olefin-CO terpolymer obtained by the process according to the invention, ammonia in liquid or dissolved form, and optionally solvents.

In a further variant, the heterogeneous hydrogenation catalyst comprises metals selected from the group comprising cobalt, nickel, ruthenium, rhodium, palladium, iridium and/or platinum. The catalysts can be used in the form of Raney catalysts or on suitable supports. It is also possible to use alloys containing the aforementioned metals. Alternatively, it is also possible to use mixtures of the aforementioned catalysts. Preference is given to using Raney cobalt, Raney nickel, or supported cobalt, nickel or ruthenium catalysts. Suitable support materials are particularly carbon and oxides, such as silicon dioxide, aluminium dioxide, mixed oxides composed of silicon dioxide and aluminium dioxide, and titanium oxide.

In a further variant of the process, the reaction is conducted at a temperature of ≧80° C. to ≦280° C. Preference is given to a temperature range of ≧160° C. to ≦240° C. Particular preference is given to a temperature range of ≧180° C. to ≦220° C.

In a further variant of the process, the reaction is conducted at a hydrogen pressure of ≧10 bar to <150 bar, preferably of ≧20 bar to ≦80 bar. Particular preference is given to a pressure range from ≧30 bar to ≦50 bar.

In a further variant of the process, the reaction is conducted with a residence time of the liquid phase in the catalyst bed of the fixed bed reactor of ≧1 second to ≦1 hour. Preferred residence times are in the range from ≧5 seconds to ≦10 minutes. Particularly preferred residence times are in the range from ≧10 seconds to ≦5 minutes.

In a further variant of the process, the molar ratio of ammonia to keto groups in the olefin-CO terpolymer used is ≧1:1 to ≦500:1. Preferred ratios are in the range from ≧3:1 to ≦100:1. Particularly preferred ratios are in the range from ≧5:1 to ≦50:1.

The olefin-CO terpolymer (obtained by the process according to the invention) can be used in liquid or molten form in pure substance, or dissolved in a solvent. In a further embodiment, the reductive amination is conducted in the presence of a solvent selected from the group comprising C₁-C₄-alcohols, 1,2-dioxane, 1,3-dioxane, 1,4-dioxane, tetrahydrofuran, 2-methyltetrahydrofuran, 3-methyltetrahydrofuran, 2,5-dimethyltetrahydrofuran, tetrahydrofurfuryl methyl ether, tetrahydrofurfuryl ethyl ether, 2,5-dimethoxymethyltetrahydrofuran, 2,5-diethoxymethyltetrahydrofuran, furfuryl acetate, tetrahydrofuran-2-carboxylic acid methyl ester, 1,3-dioxolane, tetrahydropyran and/or haloalkanes (such as dichloromethane, 1,2-dichloroethane, 1,1,2,2-tetrachloroethane or higher homologues thereof).

In a further variant, the reductive amination is performed in the presence of liquid ammonia as a solvent or with ammonia dissolved in a solvent.

In a preferred embodiment of the process, the olefin-CO terpolymer first comes into contact with the ammonia within the catalyst bed of the fixed bed reactor. In this way, formation of sparingly soluble crosslinked imines which can precipitate out is prevented.

The polyamines or polyamine-polyalcohols obtained are of particularly good suitability as co-reactants for isocyanates and epoxides, as reactants for the phosgenation to give polyisocyanates, and for the production of elastic coatings or mouldings. The conversion products with dialkyl maleates (polyaspartates) and with ketones or aldehydes (polyketimines or polyaldimines) are of particularly good suitability as co-reactants for polyisocyanates.

Finally, the use of inventive olefin-CO terpolymers, of inventive polyol compounds and/or of inventive polyamine and/or polyamine-polyalcohol compounds as polymer additives and/or for preparation of polyurethane and/or polyurea polymers also forms part of the present invention. For instance, the terpolymers may find use as co-reactants for isocyanates and epoxides, as reactants for the phosgenation to give polyisocyanates, and for the production of elastic coatings or mouldings.

The present invention is illustrated in detail by the examples which follow, but without being restricted thereto.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Description of the Methods

Reactor:

The polymerization reactions were conducted in a 300 ml stainless steel autoclave with a glass insert. The system was equipped with a mechanical stirrer and automatic internal cooling. The heating was effected by means of a heating jacket and was controlled via the internal reactor temperature. The catalyst solution was prepared in a Schlenk tube under argon and transferred with a syringe in an argon countercurrent into a gas burette which was connected to the reactor interior via an immersed tube equipped with an isolating valve. The gas mixture of gaseous olefin and CO (composition stated in % by volume) was initially charged in a mixing chamber having a volume of 3.8 l at a pressure of 60 bar. The gas was supplied to the reactor, as appropriate, via a Bronckhorst mass flow controller (MFC) (capacity 2 standard litres/min) coupled to a pressure sensor connected to the reactor interior, a bypass line or the gas burette. The reactor was charged with the gas mixture of gaseous olefin and CO at the start of the reaction via the bypass line. The catalyst solution was injected by charging the gas burette with the gas mixture of gaseous olefin and CO, and opening the connection to the reactor. The fine adjustment of the total pressure after injection of the catalyst was made using the MFC. The metered addition of the gas mixture of gaseous olefin and CO over the course of the reaction was effected via the MFC by compensation for the pressure drop which occurs during the reaction. To end the reaction, the gas supply was closed and the autoclave was cooled to room temperature with the aid of the internal cooling and optionally by means of external cooling with the aid of an ice bath or water bath.

The following reagents and gases, unless specified otherwise, were used without further purification:

ethylene (3.0), Gerling Holz & Co., Hamburg

carbon monoxide CO (3.7), Praxair, Belgium

1-hexene, CAS [592-41-6], Catalogue No. 320323, Aldrich (was distilled before use)

styrene, CAS [100-42-5], Catalogue No. W323306, Aldrich

palladium acetate (Pd(OAc)₂, CAS [3375-31-3]), Catalogue No. 379875, Aldrich

ligand P̂O (2-[bis(2-methoxyphenyl)phosphino]benzenesulphonic acid), CAS [257290-43-0], Convertex

The complex catalyst [Pd(dcpOEt)P̂O] (=[(1-η²,5-η¹-6-ethoxy-exo-5,6-dihydrodicyclopentadiene){2-[bis(2-methoxyphenyl)phosphino]benzenesulphonato}palladium]) was synthesized according to Organometallics (2005) 2754, compound 2b.

The solvent used was dichloromethane, which was dried over CaCl₂, 4 Å molecular sieve and F 200 and then degassed with argon.

Analysis:

¹H NMR spectroscopy: The measurements were effected on a Bruker AV300 (300 MHz) at 95° C.; the calibration of the chemical shifts was effected relative to the solvent signal (chlorodeuterobenzene C₆D₅Cl, shift of the low-field signal: δ=7.14 ppm; 1,2-dichlorodeuterobenzene C₆D₄Cl₂, shift of the low-field signal: δ=7.19 ppm); s=singlet, m=multiplet, bs=broadened singlet, kb=complex region. The integrals are reported relative to one another. The signals were assigned as follows (relevant group underlined):

Ethylene-CO Copolymers:

| δ [ppm] | | |
|---|---|---|
| (rough figure) | Integral | Chem. group |
| 0.7-0.95 | A | —CH₃ |
| 1.0-1.5 | B | —CH₂—CH₂—CH₂— |
| 1.5-1.7 | C | —CO—CH₂—CH₂—CH₂— |
| 1.9-2.1 | D | —CH₂—CH₂—CH═CH₂— |
| 2.1-2.3 | E | —CO—CH₂—CH₂—CH₂— |
| 2.4-2.6 | F | —CO—CH₂—CH₂—CO— |
| 4.9-5.1 | G | —CH═CH₂ |
| 5.3-5.4 | H | —CH═CH— |
| 5.7-5.9 | I | —CH═CH₂ |

The molar CO content x_{CO} (in mol %) is calculated from the area integrals A to I as follows:

$${x}_{CO} = 100 \% \times \frac{E + F}{A + B + C + D + 2 E + 2 F + G + H + I}$$

The molar ethylene content x_{ethylene} (in mol %) is calculated by:

x_{ethylene}=100%−x_{CO}

For ethylene-CO copolymers, the molar proportions xᵢ of the monomers i (ethylene or CO) can be equated to the respective proportions by weight yᵢ (in % by weight) of the monomers i.

The average molecular weight MW is calculated under the assumption that one double bond is present per polymer chain, by:

$$M W = \frac{14 \times \frac{A + B + C + D + E + F + G + H + I}{2} + 28 \times \frac{E + F}{4}}{\frac{G + H}{2}}$$

The level of branching VG is calculated by formula (II), where

$${n}_{EG , Mol} = \frac{\frac{A}{3} + \frac{G}{2}}{\frac{G + H}{2}} and$$

$${n}_{C , Mol} = \frac{\frac{A + B + C + D + E + F + G + H + I}{2} + \frac{E + F}{4}}{\frac{G + H}{2}}$$

Ethylene-CO-1-Hexene Terpolymers:

| δ [ppm] | | |
|---|---|---|
| (rough | | |
| figure) | Integral | Chem. group |
| 0.7-1.0 | A’ | —CH₃ |
| 1.0-1.5 | B’ | —CH₂—CH₂—CH₂— |
| 1.5-1.7 | C’ | —CO—CH₂—CH₂—CH₂/—CH₂CH(ⁿBu)CH₂— |
| 1.9-2.1 | D’ | —CH₂—CH₂—CH═CH₂/ |
| | | —CH₂—CH₂—CH═CH— |
| 2.1-2.3 | E’ | —CO—CH₂—CH₂—CH₂— |
| 2.4-2.6 | F’ | —CO—CH₂—CH₂—CO— |
| 4.75 | G’ | —CH₂—C(ⁿBu)═CHH’ |
| 4.9-5.1 | H’ | —CH═CH₂/—C(ⁿBu)═CHH’ |
| 5.3-5.5 | I’ | —CH═CH— |
| 5.7-5.9 | J’ | —CH═CH₂ |

The proportions by weight yᵢ of the individual monomers i (ethylene, CO and 1-hexene) are calculated from the integrals A′ to J′ as follows:

$${y}_{1 \text{-} hexene} = 100 \% \times \frac{84 \times ( \frac{{A}^{′}}{3} - \frac{{G}^{′} + {H}^{′}}{2} )}{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′ }\end{matrix}}{2} + 28 \times \frac{{E}^{′} {F}^{′}}{4}}$$

$${y}_{CO} = 100 \% \times \frac{28 \times \frac{{E}^{′} + {F}^{′}}{4}}{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′ }\end{matrix}}{2} + 28 \times \frac{{E}^{′} + {F}^{′}}{2}}$$

$${y}_{ethylene} = 100 \% - {y}_{1 \text{-} hexene} - {y}_{CO}$$

The molar proportions xᵢ of the individual monomers i (ethylene, CO and 1-hexene) are calculated from the proportions by weight yᵢ, where M_{ethylene}=28 g/mol, M_{CO}=28 g/mol and M₁₋ₕₑₓₐₙₑ=84 g/mol, as follows:

$${x}_{i} = \frac{{y}_{i} / {M}_{i}}{{\sum }_{i} {y}_{i} / {M}_{i}}$$

The average molecular weight MW is calculated under the assumption that one double bond is present per polymer chain, by:

$$M W = \frac{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′ }\end{matrix}}{2} + 28 \times \frac{{E}^{′} + {F}^{′}}{2}}{\frac{{G}^{′} + {H}^{′}}{2} + \frac{{I}^{′}}{2}}$$

The level of branching VG is calculated by formula (II), where

$${n}_{EG , Mol} = \frac{\frac{{A}^{′}}{3} + \frac{{G}^{′} + {H}^{′}}{2}}{\frac{{G}^{′} + {H}^{′}}{2} + \frac{{I}^{′}}{2}} and$$

$${n}_{C , Mol} = \frac{\frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′ }\end{matrix}}{2} + \frac{{E}^{′} + {F}^{′}}{4}}{\frac{{G}^{′} + {H}^{′}}{2} + \frac{{I}^{′}}{2}}$$

Ethylene-CO-Styrene Terpolymers:

The chemical shift was calibrated using the maximum of the methylene signal having the integral B″ (—CH₂—CH₂—CH₂—), δ=1.37 ppm.

| δ [ppm] | | |
|---|---|---|
| (rough figure) | Integral | Chem. group |
| 0.7-1.0 | A” | —CH₃ |
| 1.0-1.5 | B” | —CH₂—CH₂—CH₂— |
| 1.5-1.7 | C” | —CO—CH₂—CH₂—CH₂— |
| 1.9-2.1 | D” | —CH₂—CH₂—CH═CH₂/ |
| | | —CH₂—CH₂—CH═CH— |
| 2.1-2.3 | E” | —CO—CH₂—CH₂—CH₂— |
| 2.4-2.6 | F” | —CO—CH₂—CH₂—CO |
| 2.6-2.8 | S₁ | —CH₂—CHPh—CH₂— |
| 4.9-5.1 | H” | —CH═CH₂ |
| 5.3-5.5 | I” | —CH═CH— |
| 5.7-5.9 | J” | —CH═CH₂ |
| 6.0-6.3 | S₂ | —CH═CH—Ph |
| 6.4-6.5 | S₃ | —CH═CH—Ph |
| 6.5-6.8 | | CHₐᵣ |
| 6.9-7.6 | | CHₐᵣ |

The signals of the CHₐᵣ groups overlap with the signals of the solvent (C₆D₅Cl); therefore, the integrals of these signals cannot be used to determine the styrene content. The styrene content was therefore determined via the integrals S₁, S₂ and S₃.

The proportions by weight yᵢ of the individual monomers i (ethylene, CO and styrene) are calculated from the integrals A″ to J″ and S₁ to S₃ as follows:

$${y}_{styrene} = 100 \% \times \frac{104 \times ( {S}_{1} + {S}_{3} )}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

$${y}_{CO} = 100 \% \times \frac{28 \times \frac{{E}^{″} + {F}^{″}}{4}}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

$${y}_{ethylene} = 100 \% \times \frac{14 \times \frac{\begin{matrix}{A}^{″} + {B}^{″} + {C}^{″} + {D}^{″} + \\ {E}^{″} + {F}^{″} + {G}^{″} + {H}^{″} + {I}^{″} + {J}^{″ } - 2 \times {S}_{1}\end{matrix}}{2}}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

The molar proportions xᵢ of the individual monomers i (ethylene, CO and styrene) are calculated from the proportions by weight yᵢ, where M_{ethylene}=28 g/mol, M_{CO}=28 g/mol and M_{styrene}=104 g/mol, as follows:

$${x}_{i} = \frac{{y}_{i} / {M}_{i}}{{\sum }_{i} {y}_{i} / {M}_{i}}$$

The average molecular weight MW is calculated under the assumption that one double bond is present per polymer chain, by:

$$M W = \frac{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}{\frac{{H}^{″} + {I}^{″}}{2} + {S}_{3}}$$

The level of branching VG is calculated by formula (II), where

$${n}_{EG , Mol} = \frac{\frac{{A}^{″}}{3} + {S}_{1} + \frac{{H}^{″}}{2} + {S}_{3}}{\frac{{H}^{″}}{2} + \frac{{I}^{″}}{2} + {S}_{3}} and$$

$${n}_{C , Mol} = \frac{\begin{matrix}\frac{{A}^{″}}{3} + \frac{{B}^{″} + {C}^{″} + {D}^{″} + {E}^{″} + {F}^{″} + {H}^{″}}{2} + \\ {S}_{1} + {I}^{″} + {J}^{″} + {S}_{2} + {S}_{3}\end{matrix}}{\frac{{H}^{″}}{2} + \frac{{I}^{″}}{2} + {S}_{3}}$$

Ethylene-CO-1-Hexene Terpolymers:

Obtained by Free-Radical Terpolymerization with Azobisisobutyronitrile (AIBN) as Free-Radical Initiator (According to Comparative Example 3).

| δ [ppm] | | |
|---|---|---|
| (rough | | |
| figure) | Integral | Chem. group |
| 0.5-1.0 | A’* | —CH₃ |
| 1.0-1.4 | B’* | —CH₂—CH₂—CH₂— |
| 1.4-2.1 | C’* | —CO—CH₂—CH₂—CH₂/—CH₂CH(ⁿBu)CH₂—/ |
| | | —C(CH₃)₂CN |
| 2.1-2.5 | E’* | —CO—CH₂—CH₂—CH₂— |
| 2.5-2.8 | F’* | —CO—CH₂—CH₂—CO— |

The terpolymers obtained by free-radical terpolymerization with AIBN have, as well as the chemical groups resulting from the ethylene, 1-hexene and CO monomers, additionally isobutyronitrile groups —C(CH₃)₂CN (referred to here as IBN) resulting from the AIBN as end groups. The signals for the methyl groups present in the IBN groups overlap with the signals for the CH₂ groups in the β position to CO groups and the signals for the branching —CH(ⁿBu)- groups resulting from 1-hexene, and have to be taken into account in the calculations which follow for the monomer contents and the level of branching. The proportion of IBN groups in the integral C′* is I_{IBN}=C′*−E′*−A′*/3.

The proportions by weight yᵢ of the individual monomers i (ethylene, CO, 1-hexene, IBN) are calculated from the integrals A′* to D′* and E′* and F′* as follows:

$${y}_{1 \text{-} hexene} = 100 \% \times \frac{84 \times \frac{{A}^{′ *}}{3}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

$${y}_{CO} = 100 \% \times \frac{28 \times \frac{{E}^{′ *} + {F}^{′ *}}{4}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

$${y}_{ethylene} = 100 \% \times \frac{14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} - 84 \times \frac{{A}^{′ *}}{3}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

$${y}_{IBN} = 100 \% \times \frac{68 \times \frac{{C}^{′ *} - {E}^{′ *} - {A}^{′ *} / 3}{6}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

The proportions by weight y_{EG} of the individual end groups EG (—CH₃ and IBN) are calculated from the integrals A′* to D′* and E′* and F′* as follows:

$${y}_{- CH 3} = 100 \% \times \frac{\frac{15 \times {A}^{′ *}}{3}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

$${y}_{IBN} = 100 \% \times \frac{68 \times \frac{{C}^{′ *} - {E}^{′ *} - {A}^{′ *} / 3}{6}}{\begin{matrix}14 \times \frac{\begin{matrix}{A}^{′ *} + {B}^{′ *} + {C}^{′ *} + {E}^{′ *} + \\ {F}^{′ *} - ( {C}^{′ *} - {E}^{′ *} - {A}^{′ *} / 3 )\end{matrix}}{2} + \\ 68 \times \frac{{C}^{′ *} - {E}^{′ *} - {A}^{′ *} / 3}{6} + 28 \times \frac{{E}^{′} + {F}^{′}}{4}\end{matrix}}$$

The molar proportions xᵢ of the individual monomers i (ethylene, CO, 1-hexene, IBN) are calculated from the proportions by weight yᵢ, where M_{ethylene}=28 g/mol, M_{CO}=28 g/mol and M₁₋ₕₑₓₑₙₑ=84 g/mol, as follows:

$${x}_{i} = \frac{{y}_{i} / {M}_{i}}{{\sum }_{i} {y}_{i} / {M}_{i}}$$

The level of branching VG is calculated by formula (II), where

$${n}_{EG , Mol} = {M}_{n} \times ( \frac{{y}_{- CH 3}}{15 g \text{/} mol} + \frac{{y}_{IBN}}{68 g \text{/} mol} ) and$$

$${n}_{C , Mol} = {M}_{n} \times {\sum }_{i} \frac{{y}_{i} \times {n}_{C , i}}{{M}_{i }} ,$$

where Mₙ is the number-average molecular weight determined by gel permeation chromatography (GPC), yᵢ is the proportion by weight of the individual monomers i (ethylene, CO, 1-hexene, IBN), n_{C, i} is the number of carbon atoms present in a molecule i (2 for ethylene, 1 for CO, 6 for 1-hexene, 4 for IBN) and Mᵢ is the molar mass of the monomers i (28 g/mol for ethylene, 28 g/mol for CO, 84 g/mol for 1-hexene, 68 g/mol for IBN).

Infrared (IR) spectroscopy: The measurements were effected on a Bruker Alpha-P FT-IR spectrometer; the measurements were effected in pure substance; the wavenumber of the maximum of the signal for the CO stretching vibration ν(CO) is reported.

The viscosity was determined on a Physica MCR 501 rheometer from Anton Paar. A cone-plate configuration having a separation of 50 μm was selected (DCP25 measurement system). 0.1 g of the substance was applied to the rheometer plate and subjected to a shear of 0.01 to 1000 l/s at 160° C., and the viscosity was measured every 10 s for 10 min. The viscosity averaged over all the measurement points is reported.

The melting points were determined by DSC (differential scanning calorimetry) on a DSC 1 STAR^{e} from Mettler Toledo. The sample was analysed at a heating rate of 10 K/min over two heating cycles from −80° C. to +250° C. The melting point reported was the heat absorption maximum of the second heating rate.

Gel permeation chromatography (GPC): The molecular weight was determined by high-temperature GPC at Polymer Standards Services (PSS), Mainz. The analysis was conducted at 150° C. in 1,2,4-trichlorobenzene as the eluent at a flow rate of 1.0 ml/min. Column: PSS Polyolefin 10 μm, LinXL, ID 8.0 mm×300 mm. The calibration standards used were polystyrene samples of known molecular weight.

### Example 1

Terpolymerization of ethylene, CO and 1-hexene with a reaction time of 2 hours

A 300 ml stainless steel pressure reactor with a glass insert was initially charged with a mixture of 50 ml of dichloromethane and 50 ml of freshly distilled 1-hexene, and the reactor was flooded with argon. Subsequently, the reactor was charged at room temperature with a mixture of 98% ethylene and 2% CO to a total pressure of 10.2 bar. The mixture was then heated to 110° C. while stirring at 500 rpm, in the course of which the total pressure in the reactor rose to 17.4 bar. On attainment of the reaction temperature, the pressure was adjusted to 30.3 bar with a mixture of 98% ethylene and 2% CO. Then 14.4 mg (0.02 mmol) of [Pd(dcpOEt)P̂O] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

22.5 g of a terpolymer of ethylene, CO and 1-hexene were obtained.

Melting point: 109.91° C.

The melting range already begins at <25° C.

Viscosity in Pa·s (temperature): 0.613 (110° C.), 0.493 (120° C.), 0.404 (130° C.), 0.332 (140° C.), 0.273 (150° C.), 0.229 (160° C.).

IR: ν(CO)=1715 cm⁻¹

¹H NMR (300 MHz, C₆D₅Cl, 95° C.): δ=0.76-1.02 (35.48H), 1.02-1.45 (964.501H), 1.45-1.70 (19.38H), 1.89-2.10 (7.871H), 2.14-2.34 (9.878H), 2.40-2.60 (2.293H), 4.75 (bs, 0.453H), 4.86-5.03 (2.464H), 5.32-5.47 (1.628H), 5.69-5.86 (1.000H) ppm.

The molar proportions of the monomers in the product are 94.5 mol % of ethylene, 4.3 mol % of 1-hexene and 1.3 mol % of CO.

From the proportion of double bonds in the ¹H NMR spectrum, an average molecular weight of Mₙ=3256 g/mol is calculated.

The level of branching was VG=16.63 branches per 1000 carbon atoms.

According to GPC (150° C., 1,2,4-trichlorobenzene, calibrated against polystyrene), the product has a number-average molecular weight Mₙ=3770 g/mol and a polydispersity index PDI=2.53.

### Example 2

Terpolymerization of ethylene, CO and 1-hexene with a gas conversion of 2.5 standard litres

A 300 ml stainless steel pressure reactor with a glass insert was initially charged with a mixture of 50 ml of dichloromethane and 50 ml of freshly distilled 1-hexene, and the reactor was flooded with argon. Subsequently, the reactor was charged at room temperature with a mixture of 98% ethylene and 2% CO to a total pressure of 10 bar. The mixture was then heated to 110° C. while stirring at 500 rpm. On attainment of the reaction temperature, the pressure was adjusted to 30 bar with a mixture of 98% ethylene and 2% CO. Then 14.3 mg (0.021 mmol) of [Pd(dcpOEt)P̂O] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, until 2.5 standard litres of the gas mixture had been metered in (0.42 hour). After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

3.8 g of a terpolymer of ethylene, CO and 1-hexene were obtained.

Melting point: 112.43° C.

The melting range already begins at <50° C.

Viscosity in Pa·s (temperature): 0.875 (110° C.), 0.685 (120° C.), 0.546 (130° C.), 0.443 (140° C.), 0.363 (150° C.), 0.301 (160° C.).

IR: ν(CO)=1711 cm⁻¹

¹H NMR (300 MHz, C₆D₅Cl, 95° C.): δ=0.76-1.02 (26.48H), 1.02-1.45 (767.337H), 1.45-1.70 (24.91H), 1.89-2.10 (5.845H), 2.14-2.34 (15.47H), 2.40-2.60 (7.287H), 4.75 (bs, 0.343H), 4.86-5.03 (2.074H), 5.32-5.47 (1.315H), 5.69-5.86 (0.999H) ppm.

The molar proportions of the monomers in the product are 93.5 mol % of ethylene, 3.7 mol % of 1-hexene and 2.8 mol % of CO.

From the proportion of double bonds in the ¹H NMR spectrum, an average molecular weight of Mₙ=3282 g/mol is calculated.

The level of branching was VG=14.60 branches per 1000 carbon atoms.

According to GPC (150° C., 1,2,4-trichlorobenzene, calibrated against polystyrene), the product has a number-average molecular weight Mₙ=4580 g/mol and a polydispersity index PDI=2.41.

### Example 3

Terpolymerization of ethylene, CO and styrene with a reaction time of 2 hours

A 300 ml stainless steel pressure reactor with a glass insert was initially charged with a mixture of 50 ml of dichloromethane and 50 ml of styrene, and the reactor was flooded with argon. Subsequently, the reactor was charged at room temperature with a mixture of 98% ethylene and 2% CO to a total pressure of 12 bar. The mixture was then heated to 110° C. while stirring at 500 rpm. On attainment of the reaction temperature, the pressure was adjusted to 30 bar with a mixture of 98% ethylene and 2% CO. Then 14.4 mg (0.021 mmol) of [Pd(dcpOEt)P̂O] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

15.4 g of a terpolymer of ethylene, CO and styrene were obtained.

IR: ν(CO)=1717 cm⁻¹

¹H NMR (300 MHz, C₆D₅Cl, 95° C.): δ=0.68-1.06 (4.997H), 1.06-1.49 (336.70 H), 1.49-1.86 (23.88H), 1.93-2.15 (3.492H), 2.15-2.41 (10.83H), 2.63-2.78 (4.795H), 2.78-2.89 (1.200H), 4.92-5.11 (1.000H), 5.43-5.75 (0.227H), 5.75-5.91 (0.459H), 6.08-6.30 (1.226H), 6.30-6.48 (1.304H), 6.84-6.89 (6.568H), 6.89-7.58 (37.77H) ppm.

The molar proportions of the monomers in the product are 93.5 mol % of ethylene, 2.5 mol % of styrene and 3.8 mol % of CO.

From the proportion of double bonds in the ¹H NMR spectrum, an average molecular weight of Mₙ=1590 g/mol is calculated.

The level of branching was VG=3.88 branches per 1000 carbon atoms.

Melting point: 112.54° C.

The melting range already begins at <60° C.

Viscosity in Pa·s (temperature): 1.269 (110° C.), 1.021 (120° C.), 0.8791(130° C.), 0.7344 (140° C.), 0.6906 (150° C.), 0.5585 (160° C.).

According to GPC (150° C., 1,2,4-trichlorobenzene, calibrated against polystyrene), the product has a number-average molecular weight Mₙ=3870 g/mol and a polydispersity index PDI=1.45.

### Example 4

Terpolymerization of ethylene, CO and styrene with a gas conversion of 2.5 standard litres

A 300 ml stainless steel pressure reactor with a glass insert was initially charged with a mixture of 50 ml of dichloromethane and 50 ml of styrene, and the reactor was flooded with argon. Subsequently, the reactor was charged at room temperature with a mixture of 98% ethylene and 2% CO to a total pressure of 11.7 bar. The mixture was then heated to 110° C. while stirring at 500 rpm. On attainment of the reaction temperature, the pressure was adjusted to 30 bar with a mixture of 98% ethylene and 2% CO. Then 14.5 mg (0.021 mmol) of [Pd(dcpOEt)P̂O] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, until 2.5 standard litres of the gas mixture had been metered in (0.65 hour). After the reaction time was complete, the reactor was cooled down to 25° C. and the pressure was released cautiously. The reaction mixture obtained was cautiously filtered and the solid residue washed with dichloromethane. The volatile constituents of the filtrate were removed by distillation under reduced pressure. 3.5 g of a terpolymer of ethylene, CO and styrene were obtained.

Melting point: 112.68° C.

The melting range already begins at <60° C.

Viscosity in Pa·s (temperature): 0.6902 (110° C.), 0.573 (120° C.), 0.4704 (130° C.), 0.3942 (140° C.), 0.3303 (150° C.), 0.323 (160° C.).

IR: ν(CO)=1716 cm⁻¹

¹H NMR (300 MHz, C₆D₅Cl, 95° C.): δ=0.73-1.03 (5.347H), 1.03-1.52 (447.19H), 1.52-1.82 (26.68H), 1.94-2.13 (2.564H), 2.13-2.41 (15.48H), 2.41-2.61 (4.241H), 2.61-2.77 (1.264H), 4.90-5.09 (0.999H), 5.42-5.50 (0.0863H), 5.73-5.91 (0.467H), 6.11-6.27 (1.120H), 6.32-6.47 (1.171H), 6.47-6.82 (3.522H), 6.89-7.58 (37.04H) ppm.

The molar proportions of the monomers in the product are 94.5 mol % of ethylene, 1.8 mol % of styrene and 3.7 mol % of CO.

From the proportion of double bonds in the ¹H NMR spectrum, an average molecular weight of Mₙ=2261 g/mol is calculated.

The level of branching was VG=4.71 branches per 1000 carbon atoms.

According to GPC (150° C., 1,2,4-trichlorobenzene, calibrated against polystyrene), the product has a number-average molecular weight Mₙ=3420 g/mol and a polydispersity index PDI=1.63.

### Comparative Example 1

Copolymerization of ethylene and CO with a reaction time of 2 hours

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 21 bar. The mixture was then heated to 110° C. while stirring at 500 rpm, in the course of which the total pressure in the reactor rose to 17.4 bar. On attainment of the reaction temperature, the pressure was adjusted to 34 bar with a mixture of 98% ethylene and 2% CO. Then 14.4 mg (0.021 mmol) of [Pd(dcpOEt)P̂O] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

13.8 g of a copolymer of ethylene and CO were obtained.

Melting point: 126.13° C.

Viscosity in Pa·s (temperature):

1.463 (120° C.), 1.191 (130° C.), 0.9778 (140° C.), 0.8143 (150° C.), 0.6687 (160° C.).

At 110° C., the sample was in the solid state. A viscosity measurement was therefore impossible at this temperature.

IR: ν(CO)=1712 cm⁻¹

¹H NMR (300 MHz, C₆D₄Cl₂, 95° C.): δ=0.77-0.93 (9.156H), 0.93-1.41 (990.10H), 1.41-1.67 (29.41H), 1.87-2.06 (3.637H), 2.16-2.37 (20.96H), 2.44-2.64 (8.537H), 4.83-5.00 (2.567H), 5.30-5.43 (0.226H), 5.65-5.83 (1.002H) ppm.

The molar proportions of the monomers in the product are 97.3 mol % of ethylene and 2.7 mol % of CO.

From the proportion of double bonds in the ¹H NMR spectrum, an average molecular weight of Mₙ=5489 g/mol is calculated.

According to GPC (150° C., 1,2,4-trichlorobenzene, calibrated against polystyrene), the product has a number-average molecular weight Mₙ=6440 g/mol and a polydispersity index PDI=2.28.

Comparison:

The comparison of Comparative Example 1 (ethylene-CO copolymer) with Example 1 (ethylene-1-hexene-CO terpolymer) and Example 3 (ethylene-styrene-CO terpolymer) shows clearly that, in the absence of a second olefin, under otherwise identical reaction conditions (gas composition, pressure, temperature, reaction time), a polymer having a higher melting point, higher melt viscosities at the same temperatures and a higher number-average molecular weight is obtained.

### Comparative Example 2

Copolymerization of ethylene and CO with a gas conversion of 2.5 standard litres

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 11.6 bar. The mixture was then heated to 110° C. while stirring at 500 rpm. On attainment of the reaction temperature, the pressure was adjusted to 27.8 bar with a mixture of 98% ethylene and 2% CO. Then 14.3 mg (0.021 mmol) of [Pd(dcpOEt)P̂O] were dissolved in 3 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, until 2.5 standard litres of the gas mixture had been metered in (0.85 hour). After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

2.8 g of a copolymer of ethylene and CO were obtained.

Melting point: 126.16° C.

Viscosity in Pa·s (temperature):

2.3 (120° C.), 1.98 (130° C.), 1.652 (140° C.), 1.302 (150° C.), 0.778 (160° C.).

At 110° C., the sample was in the solid state. A viscosity measurement was therefore impossible at this temperature.

IR: ν(CO)=1709 cm⁻¹

¹H NMR (300 MHz, C₆D₄Cl₂, 95° C.): δ=0.67-0.91 (15.10H), 0.91-1.42 (1540,40H), 1.86-2.10 (5.901H), 2.10-2.41 (74.89H), 2.41-2.77 (25.68H), 4.83-5.01 (2.009H), 5.24-5.48 (2.495H), 5.65-5.85 (0.999H) ppm.

The molar proportions of the monomers in the product are 94.58 mol % of ethylene and 5.42 mol % of CO.

From the proportion of double bonds in the ¹H NMR spectrum, an average molecular weight of Mₙ=5769 g/mol is calculated.

Comparison:

The comparison of Comparative Example 2 (ethylene-CO copolymer) with Example 2 (ethylene-1-hexene-CO terpolymer) and Example 4 (ethylene-styrene-CO terpolymer) shows clearly that, in the absence of a second olefin, under otherwise identical reaction conditions (same gas composition, pressure, temperature, same gas conversion), a polymer having a higher melting point, higher melt viscosities at the same temperatures and a higher number-average molecular weight is obtained.

### Comparative Example 3

Free-radical terpolymerization of ethylene, CO and 1-hexene with AIBN as a free-radical initiator corresponding to Example 1 from WO 2011/110535 A2

A 200 ml pressure reactor was initially charged with 50 ml of hexene, 50 ml of methylcyclohexane and 1 g of AIBN. 50 bar of ethylene, 10 bar of carbon monoxide and 20 bar of hydrogen were injected and the mixture was heated to 80° C. for 18 h. After filtration and removal of the volatile constituents on a rotary evaporator, the product was obtained as a colourless to yellow oil.

Experiment 1

Yield: 5.3 g

According to GPC (tetrahydrofuran, calibrated against polystyrene), the product had a number-average molecular weight Mₙ=1301 g/mol and a polydispersity index PDI=1.75.

By elemental analysis, a nitrogen content of 2.91% was determined.

¹H NMR (300 MHz, C₆D₄Cl₂, 95° C.): δ=0.5-0.9 (22.88H), 0.9-1.4 (63.27H), 1.4-2.1 (18.91H), 2.1-2.5 (7.863H), 2.5-2.8 (1.000H) ppm.

The proportion by weight of CO was 7.1% by weight.

The molar proportions of the monomers in the product were 14.72 mol % of CO, 30.82 mol % of ethylene, 50.67 mol % of 1-hexene and 3.79 mol % of IBN.

The level of branching was VG=112.2 branches per 1000 carbon atoms.

Experiment 2

Yield: 3.4 g

According to GPC (tetrahydrofuran, calibrated against polystyrene), the product had a number-average molecular weight Mₙ=992 g/mol and a polydispersity index PDI=1.57.

By elemental analysis, a nitrogen content of 4.49% was determined.

¹H NMR (300 MHz, C₆D₄Cl₂, 95° C.): δ=0.5-0.9 (6.0667H), 0.9-1.4 (12.3628H), 1.4-2.1 (4.7751H), 2.1-2.5 (7.936H), 2.5-2.8 (1.000H) ppm.

The proportion by weight of CO was 9.9% by weight.

The molar proportions of the monomers in the product were 23.3 mol % of CO, 8.2 mol % of ethylene, 64.2 mol % of 1-hexene and 4.3 mol % of IBN.

The level of branching was VG=121.7 branches per 1000 carbon atoms.

Experiment 3

Yield: 3.4 g

According to GPC (tetrahydrofuran, calibrated against polystyrene), the product had a number-average molecular weight Mₙ=1106 g/mol and a polydispersity index PDI=1.62.

By elemental analysis, a nitrogen content of 3.5% was determined.

¹H NMR (300 MHz, C₆D₄Cl₂, 95° C.): δ=0.5-0.9 (131.5882H), 0.9-1.4 (265.7257H), 1.4-2.1 (98.8046H), 2.1-2.5 (41.246H), 2.5-2.8 (19.246H) ppm.

The proportion by weight of CO was 9.7% by weight.

The molar proportions of the monomers in the product were 23.2 mol % of CO, 6.2 mol % of ethylene, 67.1 mol % of 1-hexene and 3.5 mol % of IBN.

The level of branching was VG=126.7 branches per 1000 carbon atoms.

Comparison:

Comparative Example 3 (ethylene-1-hexene-CO terpolymer, obtained by free-radical polymerization, corresponding to Example 1 from WO 2011/110535 A2) shows clearly that the ethylene-1-hexene-CO terpolymers obtained by a free-radical polymerization process and disclosed in WO 2011/1105535 A2 are fundamentally different in structural terms from the ethylene-1-hexene-CO terpolymers obtained in Inventive Examples 1 and 2. The ethylene-1-hexene-CO terpolymers obtained in Comparative Example 3, in contrast to the inventive ethylene-1-hexene-CO terpolymers, have a molar CO content of >10 mol % and a level of branching of >60 branches per 1000 carbon atoms.

Examples 1 to 4 demonstrate clearly that the process according to the invention gave olefin-CO terpolymers in which the second olefin is an aliphatically substituted olefin (1-hexene, Examples 1 and 2) or an aromatically substituted olefin (styrene, Examples 3 and 4).

In addition, a comparison of Comparative Examples 1 and 2 (ethylene-CO copolymers) with Examples 1 and 2 (ethylene-1-hexene-CO terpolymers) and Examples 3 and 4 (ethylene-styrene-CO terpolymers) shows that, irrespective of the reaction conditions used, in the absence of a second olefin, it is generally the case that polymers having higher melting points, higher melt viscosities at equal temperatures and higher molecular weights are obtained, irrespective of whether the second olefin is an aliphatically substituted olefin (1-hexene) or an aromatically substituted olefin (styrene).

Comparative Example 3 shows that free-radical polymerization processes give olefin-CO terpolymers which differ fundamentally in structural terms from the inventive olefin-CO terpolymers.

1. A process for preparing an olefin-CO terpolymer, comprising the steps of:
providing a reactor;
charging the reactor with a first, gaseous olefin and with CO, such that there is a first pressure p1 in the reactor;
reacting the first olefin with CO in the presence of a catalyst in the reactor;
wherein a second olefin is initially charged in the reactor and/or metered in during the reaction,
prior to the reaction either no CO is present in the reactor or the volume ratio of first, gaseous olefin to CO is >60:40 and
during the reaction the average over time of the volume ratio of gaseous olefin metered in to CO metered in is >60:40.

2. The process according to claim 1, wherein gaseous olefin and CO are metered in at least intermittently during the reaction, with an average over time of the volume ratio of the gaseous olefin metered in to CO metered in of >60:40.

3. The process according to claim 1, wherein the pressure in the reactor during the reaction is in the range from ≧80% of p1 to ≦120% of p1.

4. The process according to claim 1, wherein a pressure drop which occurs during the reaction is balanced out by feeding further gaseous olefin and CO into the reactor, and wherein the average over time of the volume ratio of the further gaseous olefin fed in to the further CO fed in is >60:40.

5. The process according to claim 1, wherein the catalyst comprises palladium.

6. The process according to claim 1, wherein the reaction of the first olefin with CO is preceded by a homopolymerization of the first olefin or a copolymerization of a plurality of olefins in the reactor in the absence of CO.

7. The process according to claim 1, wherein the pressure p1 is ≧20 bar to ≦300 bar.

8. The process according to claim 1, wherein the reaction is performed at a temperature of ≧90° C. to ≦150° C.

9. The process according to claim 1, wherein the catalyst or a mixture of the catalyst components is injected at a temperature of ≧90° C. to ≦150° C. into the reactor containing first and/or second olefin or a mixture of first and/or second olefin and CO.

10. An olefin-CO terpolymer obtained by the process according to claim 1, wherein the content of CO incorporated into the terpolymer is ≦10 mol % based on all the monomers incorporated and the level of branching is <60 branches per 1000 carbon atoms incorporated within the olefin-CO terpolymer.

11. The olefin-CO terpolymer according to claim 10 having a number-average molecular weight Mₙ of ≦15 000 g/mol.

12. The olefin-CO terpolymer according to claim 10 having a melting point of ≦115° C.

13. A polyol compound obtained by reduction of the olefin-CO terpolymer according to claim 10.

14. A polyamine and/or polyamine-polyalcohol compound obtained by reductively aminating the olefin-CO terpolymer of claim 10.

15. A method for the preparation of a polyurethane and/or polyurea polymer comprising utilizing the olefin-CO terpolymer of claim 10 as an a polymer additive.

16. A method for the preparation of a polyurethane and/or polyurea polymer comprising utilizing the polyol compound according to claim 13 as an a polymer additive.

17. A method for the preparation of a polyurethane and/or polyurea polymer comprising utilizing the polyamine and/or the polyamine-polyalcohol compound according to claim 14 as an a polymer additive
